(19) United States
(12) Patent Application Publication
(10) Pub. No.: US 2020/0237483 A1
(43) Pub. Date: Jul. 30, 2020

(54) SOCKET GRAFTING PLUGS SYSTEM

(71) Applicant: VP INNOVATO HOLDINGS LTD., Lamaca (CY)

(72) Inventors: Ioannis VERGOULLIS, Rhodes (GR); Georgios PAPADOPOULOS, Rhodes (GR)

(21) Appl. No.: 16/726,009

(22) Filed: Dec. 23, 2019

(30) Foreign Application Priority Data
Jan. 24, 2019 (GR) 20190100040

(51) Int. Cl. A61C 8/00; A61C 13/00

(52) U.S. Cl. CPC A61C 8/008; A61C 2008/0046; A61C 13/0004; A61C 8/0016

(57) ABSTRACT

A socket grafting plugs system for use in a socket grafting process. Each socket grafting plug has a first cross section, a second cross section parallel to the first cross section and a body portion extending between the first cross section and the second cross section. The first cross section belongs to a group of first plug sections with at least a combination of three different shapes with three different sizes.

### CROSS REFERENCE TO RELATED APPLICATIONS

The present application claims priority to Greek patent application No. 20190100040 filed on Jan. 24, 2019, the contents of which are incorporated herein by reference in their entirety.

### FIELD

The present disclosure relates to tools used by dentists for performing operations, and more particularly, socket grafting operations.

### BACKGROUND

Socket grafting or socket preservation is a dental technique which involves the extraction of a hopeless tooth, followed by the placement of a bone replacement graft inside the extraction socket, the containment of the graft with elements such as a moldable membrane or collagen sponge and the securement of the latter with sutures.

The goal of the technique is to preserve the hard tissue architecture at the site in order for the latter to be able to receive a dental implant. The problem with the technique is that it makes use of some elements to contain the graft in place, which require flap elevation and suturing and thus lead to loss of the soft tissue architecture. Moreover, these elements are made of materials that are moldable and do not possess properties (stable dimensions) that can support the soft tissue (vertically and laterally) and maintain its shape and anatomy over the necessary period of healing. As a result, the soft tissue zone collapses during the healing period and the ridge presents a flat architecture that does not resemble the one present at the time of extraction, which is anatomical in shape.

### SUMMARY

The teachings of the present disclosure provide an alternative solution for this problem by means of a socket grafting plugs system according to the main claims of the present application. Preferred embodiments of the disclosure are defined in dependent claims.

Unless otherwise defined, all terms (including technical and scientific terms) used herein are to be interpreted as is customary in the art. It will be further understood that terms in common usage should also be interpreted as is customary in the relevant art and not in an idealised or overly formal sense unless expressly so defined herein.

In this text, the term “comprises” and its derivations (such as “comprising”, etc.) should not be understood in an excluding sense, that is, these terms should not be interpreted as excluding the possibility that what is described and defined may include further elements, steps, etc.

In a first inventive step, the invention provides a socket grafting plugs system configured to be used in a socket grafting process, the system comprising a plurality of socket grafting plugs, each socket grafting plug comprising

a first cross section with a first surface,

a second cross section with a second surface, the second surface being smaller than the first surface, the second cross section being parallel to the first cross section and being configured to rest on an open hole of a patient's cervical soft tissue profile;

a body portion extending between the first cross section and the second cross section,

wherein the first cross section of each socket grafting plug belongs to a group of first plug sections comprising at least a combination of three different shapes with three different sizes,
wherein the group of first cross sections and/or the group of second cross sections comprises triangles with rounded edges, squares with rounded edges, a parallelogram with rounded edges or an ovoid.

This invention provides a set with a plurality of socket grafting plugs. Each plug comprises first and second cross sections and a body portion. Each plug comprises a first cross section which is different from the first cross section of a different plug of the system. These first cross sections are selected from a group which comprises a combination of different features, such as shapes and sizes, but not only. For example, a group of plugs comprises three different sizes (small, medium and large), three different shapes (triangular, rectangular and ovoid) and three different types of body portions (straight, soft and curved), the socket grafting plugs system comprises 27 different plugs. As a consequence, the most suitable plug may be selected to be part of the socket grafting process, depending on the shape of the patient's jaw and natural dentition, so that the first cross section may copy the shape of the open end of the soft tissue zone.

This element is configured to assist with the sealing of the open end of the socket providing adequate containment of the regenerative materials within the extraction socket and to further assist with the support and maintenance of the soft tissue zone dimensions and shape three-dimensionally. As a consequence, a socket grafting plug should be understood as a dental part which aims to close the open end of a socket which has been created after a tooth removal. It is not intended to be implanted or to reach the hard tissue zone in the patient's jaw, but it is made of a material which provides dimensional stability, so that it is able to support the cervical soft tissue profile.

The first and second cross sections are a geometric definition of two planes which substantially correspond to the upper portion and the lower portion of the plug. The first cross section is intended to be placed far from the patient's jaw and the second cross section is intended to be placed opposite, inside the socket, resting on the patient's cervical soft tissue profile.

A socket grafting plug is not intended to be implanted into the patient's jaw; on the contrary, is meant to be maintained for a relatively short period of time so that it does not become integrated thus ankylosed into the patient's jaw. This socket grafting plug is configured to be retrievable and to keep stable dimensions.

The socket grafting plugs of the present invention may be therefore identified by the shape of the first cross section or the second cross section, which are the top portion or the bottom portion of the plug, the portion which is farthest from patient's jaw. This way of identifying the main shape of the plug is an easy way of choosing a preliminary shape for each particular type of socket.

In some particular embodiments, the body portion of each socket grafting plug belongs to a group of body portions which comprises continuous and derivable surfaces.

In each of the plugs, the body portion is intended to be in contact with soft and/or hard tissue. The absence of sharp edges is beneficial for the subsequent healing process.

In some particular embodiments, the continuous and derivable surfaces comprise combinations of plane, convex and concave surfaces.

This structure of plane, convex and concave portions is natural for the healing tissue, thus contributing for a natural healing process.

In some particular embodiments, the socket grafting plugs are made of a resin, a ceramic material, zirconia, PEEK, PEKTON, PMMA, PTFE, silicone, plastic, metal, a combination of at least two of them, or any other biocompatible material that can maintain stable dimensions.

These materials ensure dimensional stability, which is advantageous for the correct operation of the socket grafting plugs.

The shapes of a triangle with rounded edges, square with rounded edges, parallelogram with rounded edges or ovoid are a way of defining these shapes. As may be seen throughout the document, the “ovoid” shape has four curved sides with four rounded corners, but any other suitable shape may be chosen in order to adjust to the open end of the socket.

In some particular embodiments, at least one of the socket grafting plugs comprise a passing bore or a groove, suitable for a suture to pass through.

These open bores or grooves could be located on the first section, the second section or the body portion, and provide means for ensuring the stabilization of the plug after its installation.

In some particular embodiments, each socket grafting plug comprises at least one mark configured to provide information about the shape, size and/or the height of the socket grafting plug.

These marks provide a way of easy identification of each plug, so that the dental practitioner may identify the most suitable element to be used.

In some particular embodiments, at least one of the socket grafting plugs comprises a sharp protrusion protruding from the second cross section, the protrusion being intended to be nailed into soft tissue zone and/or hard tissue zone, thus aiming to improve the stabilization of the socket grafting plug in place.

This sharp protrusion, which may be in the shape of a needle or a nail, is intended to fix the plug to the soft or hard tissue, thus causing the stabilization of the plug to achieve a controlled healing process.

In some particular embodiments, at least one of the socket grafting plugs comprises at least one wing, which protrudes from the first section or the body section, the wing being suitable to secure the plug to another tooth.

This wing could further assist for the connection and/or stabilization of the plug to the adjacent teeth by the addition of suitable flowable, curable material. This wing may protrude from the first cross section or from the body portion.

In some particular embodiments, the height of each socket grafting plug is defined by the distance between the first cross section and the second cross section, and particularly wherein this height is classified in ten different heights, namely 2.5 mm, 3.0 mm, 3.5 mm, 4.0 mm, 4.5 mm, 5.0 mm, 5.5 mm, 6.0 mm, 6.5 mm and 7.0 mm. It should be understood that these heights are just a particular example based on currently available data and can be further adjusted or enriched if clinical needs in the future demand to do so.

The relevant height of a plug is not always the total height thereof. The distance between the first and second cross sections is a good indicator, since sometimes the upper end and/or the lower end of the plug is not totally plane.

Depending on the features of patient's teeth, it will be suitable to choose a plug belonging to one of these height categories.

In some particular embodiments, size of each socket grafting plug is defined by the equivalent diameter of the first cross section, wherein the equivalent diameter is the maximum distance between two points belonging to said cross section, this size being classified into at least three categories, the small one being comprised between 4 and 6 mm, the medium one being comprised between 6.5 and 8.5 mm and the big one being comprised between 9 and 12 mm.

The size of the plug is another key feature, which is chosen depending on the type of the tooth and on the patient itself. In particular cases, this size category depends on the shape of the plug. For example, a triangular shape will be available in three sizes, a small size of 4.5 mm, a medium size of 6 mm and a large size of 7 mm. But another shape, such as a parallelogram size, may be available in a small size of 6 mm, a medium size of 7 mm and a large size of 8 mm.

In some particular embodiments, at least one of the socket grafting plugs have a circular second cross section

A circular second cross section, which is usually the portion with minimum equivalent diameter is advantageous, since a circular profile is mostly needed at the area where the bottom of the plug is to be located.

In some particular embodiments, at least one of the socket grafting plugs comprises a passing hole, the passing hole crossing the plug from the first cross section to the second cross section and having a diameter of at least 1.5 mm.

The position of this passing hole may be central or offset in the first cross section of the plug. This hole has an axis that may be perpendicular to the first and second cross sections or not. This passing hole could be used in order to properly direct a suitable implant drill that can pass through this bore and mark an implant osteotomy to the underlying bone. This passing hole could be also used for a pillar of an abutment to pass through, but preventing the abutment shoulder to be inserted in it. This would allow the socket grafting plug to be able to be connected with an abutment by means of bonding on at least part of its pillar and this way modify the shape of the latter.

In some particular embodiments, at least one of the socket grafting plugs is made of a material with scannable properties that allow it to be scanned with the use of an intra-oral scanner. The scanning of this “scannable” socket grafting plug will be able to be identified into a suitable digital library available in a suitable software so that the information with regards to the shape and dimensions of this plug being provided to the practitioner.

The socket grafting plugs may be manufactured through an injection mold apparatus that comprises wells which resemble the shapes and dimensions of the plugs. Said mold apparatus receives a flowable biocompatible material that will fill these wells by injection. Then, the flowable, curable material is left to completely cure and set, thus creating the inventive plugs.

Alternatively, the inventive plugs could also be fabricated through milling utilizing CAD-CAM protocols, using pre-fabricated blocks of suitable material and known dimensions and shapes which are part of a digital library. Where said block is installed in a CAM machinery and subsequently milled, utilizing the CAD protocols and available data from the digital library, the inventive plugs are produced.

In some particular embodiments, at least one of the socket grafting plugs comprise a body portion which comprises a regular surface, as that which may be expressed by a polynomic, exponential or logarithmic mathematical formula, or a combination thereof, with a mean roughness Ra lower than 10 μm.

These plugs have a regular and smooth surface, which is more favorable for the patient's healing tissue profile and allow better hard and soft tissue adaptation.

In a second inventive aspect, the invention provides a use of a socket grafting plugs system according to the first inventive aspect in a dental action comprising the following steps:

evaluate the shape and dimensions of an open end of a soft tissue zone after a tooth removal;

filling a hard tissue zone with suitable regenerative material or left to fill in with the patient's own blood clot

choosing a socket grafting plug from the socket grafting plugs system, the socket grafting plug having a suitable shape and size according to the evaluation of the first step

installing the socket grafting plug so that the open end is substantially sealed and at least part of the soft and/or hard tissue zone is occupied by the plug's body portion.

A set of plugs will assist with the sealing of the open end of the socket providing adequate containment of the regenerative materials within the extraction socket and will further assist with the support and maintenance of the soft tissue zone dimensions and shape three-dimensionally.

In a particular embodiment, the plug is further stabilized in position by a suitable element, such as a suture engaging the adjacent tissue and/or teeth, or even by addition of a flowable, curable material that connects at least part of the plug with at least part of the crowns of the adjacent teeth.

In a particular embodiment, the socket grafting plugs system comprises a passing hole, and the use further comprises the steps of

drilling a hard tissue by a drill which passes through the passing hole;

removing the socket grafting plug;

placing an implant and connecting an abutment with the implant, the abutment comprising a pillar;

installing the socket grafting plug on the pillar of the abutment and stabilizing the socket grafting plug in a desired position so that it further maintains the shape of soft tissue anatomy, as all the steps are aimed to maintain this shape.

### BRIEF DESCRIPTION OF THE DRAWINGS

To complete the description and in order to provide for a better understanding of the invention, a set of drawings is provided. Said drawings form an integral part of the description and illustrate an embodiment of the invention, which should not be interpreted as restricting the scope of the invention, but just as an example of how the invention can be carried out. The drawings comprise the following figures:

FIG. 1 shows a generic view of a socket grafting plugs system according to the invention.

FIG. 2 shows a vertical section view of a particular embodiment of a socket grafting plug belonging to a socket grafting plugs system according to the invention.

FIGS. 3a and 3b show the first and the second cross sections of a plug of a socket grafting plugs system according to the invention.

FIGS. 4a to 4c show different side views of different examples of plugs according to the invention.

FIGS. 5a and 5b show particular details of different plugs of a socket grafting plugs system according to the invention.

FIGS. 6 to 8 show different embodiment of plugs of a socket grafting plugs system according to the invention.

### DETAILED DESCRIPTION

The example embodiments are described in sufficient detail to enable those of ordinary skill in the art to embody and implement the systems and processes herein described. It is important to understand that embodiments can be provided in many alternate forms and should not be construed as limited to the examples set forth herein.

Accordingly, while embodiment can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

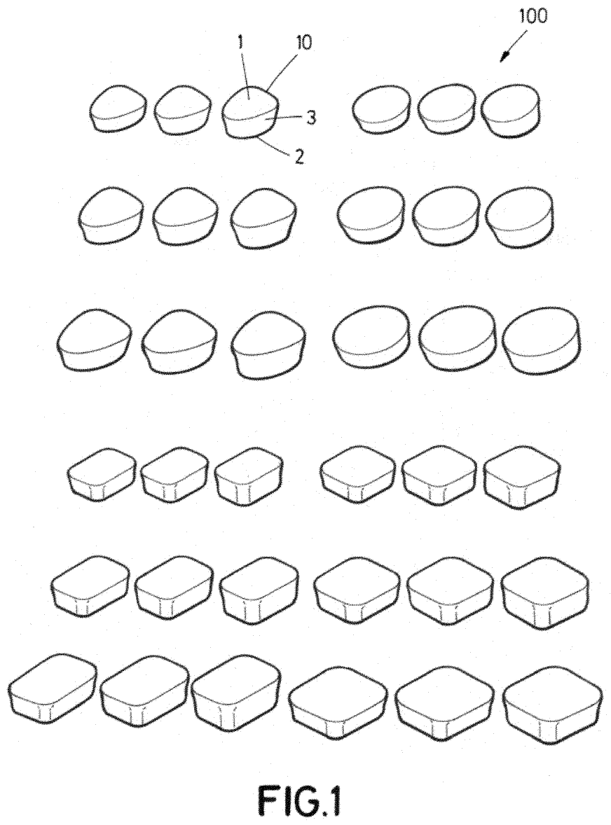

FIG. 1 shows a generic view of a socket grafting plugs system 100 according to the invention. This socket grafting plugs system is suitable for being used in a socket grafting process.

As will be shown below, each plug 10 belonging to the system 100 comprises a first cross section 1, a second cross section 2 and a body portion 3. The first cross section 1 is different for each plug.

This system 100 comprises 36 plugs 10, which responds to the combination between four different shapes (rectangular with round edges, triangular with round edges, ovoid and square with round edges), three different sizes (small, medium and large) and three different heights (short, medium and long).

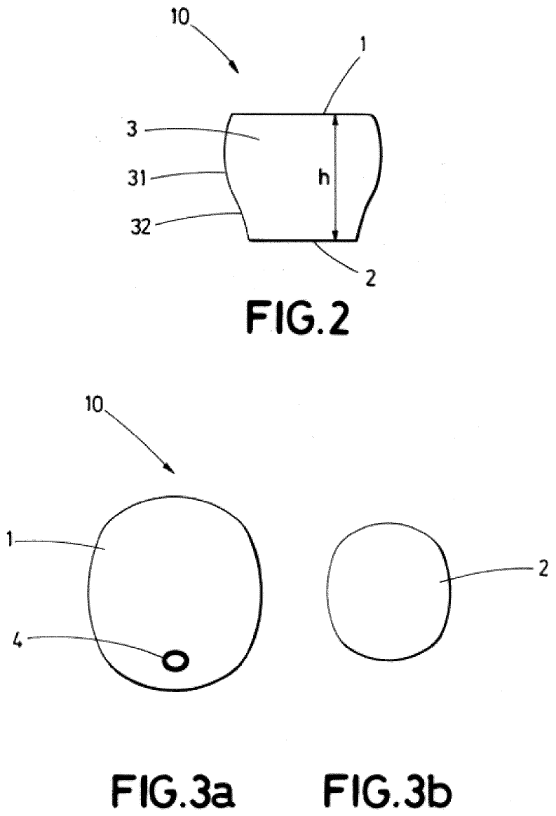

FIG. 2 shows a vertical section view of a particular embodiment of a plug 10 belonging to a socket grafting plugs system according to the invention.

As aforementioned, this plug 10 comprises a first cross section 1, a second cross section 2 and a body portion 3 which extends between the first cross section 1 and the second cross section 2. The first cross section 1 is intended to be placed upwards, while the second cross section 2 is intended to be placed downwards in a standard use of this plug 10, resting on the open hole of a patient's cervical soft tissue profile. The first 1 and second 2 sections are parallel, and the second section 2 comprises a smaller surface than the first surface of the first cross section 1.

The lateral surface of the body portion 3 form a continuous and derivable surface. This surface comprises a convex portion 31 and a concave portion 32, although in different plugs, the body portion may also comprise plane portions.

The height h of the body portion of this plug 10 is defined as the distance between the first cross section and the second cross section.

These plugs 10 are made of resin, or zirconia, or peek, or PMMA, or, plastic, or titanium, or metal, or any other material which is a biocompatible material which provides a good dimensional stability, which is advantageous for the grafting process.

FIGS. 3a and 3b show the first and second cross sections of a particular example of a plug 10. FIG. 3a shows the first cross section 1 which is an ovoid with rounded edges. On the contrary, FIG. 3b shows in turn the second cross section 2 of the same plug 10, which has the shape of a circle.

This particular embodiment of plug 10 comprises a mark 4, containing information about the shape, the size and the height of the plug 10, which may be easily read and interpreted by a scanning tool or just by the dental practitioner, in order to easily identify the most suitable plug for each dental operation. In other embodiments, the number of marks may be greater than one.

The size of the plug is defined by the equivalent diameter of the first cross section 1. As a consequence, in this case, this plug would be considered as an ovoid plug. However, the rounded cylindrical shape in the bottom portion shown in FIG. 3b is advantageous, since maximum tissue thickness is desired in this zone and a circular cylindrical shape is advantageous to provide the least diameter circumferentially in comparison to other shapes.

The size may be classified into at least three categories, the small one being comprised between 4 and 6 mm, the medium one being comprised between 6.5 and 8.5 mm and the big one being comprised between 9 and 12 mm. the height of each socket grafting plug is defined by the distance between the first cross section and the second cross section, and particularly wherein this height is classified in ten different heights, namely 2.5 mm, 3.0 mm, 3.5 mm, 4.0 mm, 4.5 mm, 5.0 mm, 5.5 mm, 6.0 mm, 6.5 mm and 7.0 mm.

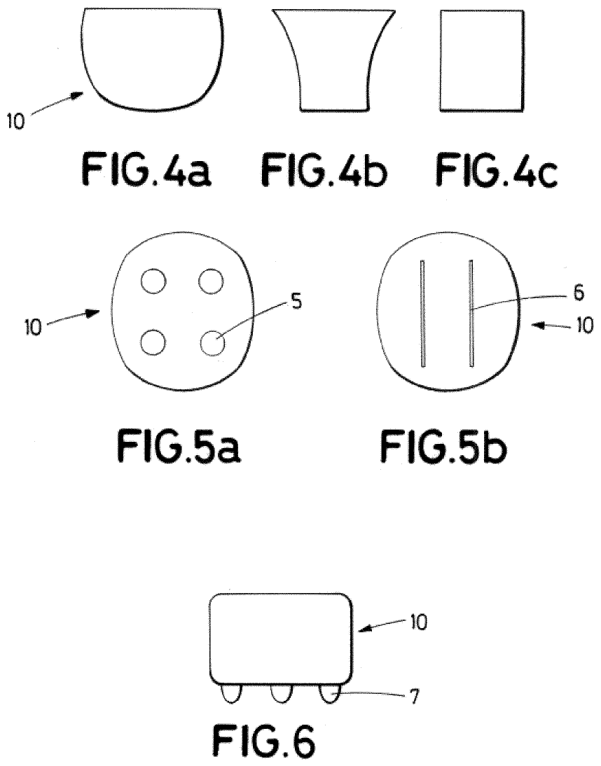

This plug starts with a cylindrical shape and then expands laterally upwards in a concave manner till it reaches its maximum diameter and at which point comprises a generally ovoid shape with rounded edges. However, many different structures are also possible, depending on the strategy chosen by the dental practitioner. FIGS. 4a to 4c show different side views of different examples of plugs according to the invention.

FIG. 5a shows a particular embodiment of a plug 10 which comprises a passing bore 5, which is useful for a suture to pass through when the plug 10 is installed in an open end of a socket and this plug 10 is to be fixed to the patient's mouth. An alternative embodiment may be seen in FIG. 5b, where a plug comprises a groove 6, so that this suture may be also stabilized.

FIG. 6 shows a particular embodiment of a plug 10 which comprises a sharp protrusion 7 protruding from the second cross section 2. This protrusion 7 is intended to be nailed into soft tissue zone and/or hard tissue zone, thus aiming to improve the stabilization of the socket grafting plug in place.

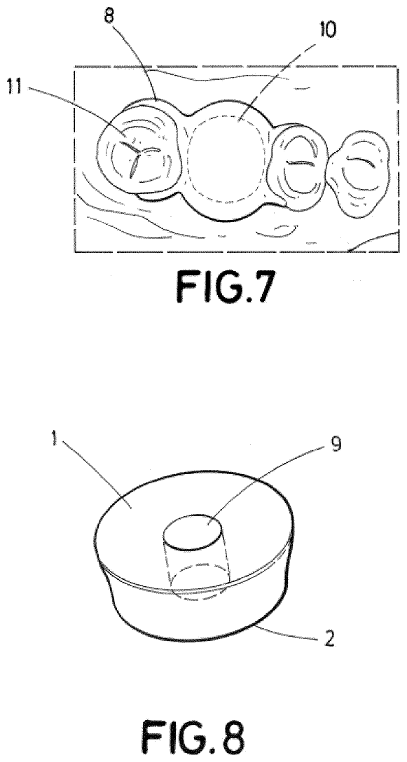

FIG. 7 shows a particular embodiment of a plug 10 which comprises at least one wing 8, which protrudes from the first section or the body section, the wing being suitable to secure the plug to another tooth 11.

FIG. 8 shows a particular embodiment of a plug 10 which comprises a passing hole 9, the passing hole crosses the plug from the first cross section 1 to the second cross section 2 and being suitable for a drill to pass through. This hole has an axis that may be perpendicular to the first and second cross sections or not. This passing hole may be used in order to properly direct a suitable implant drill that can pass through this bore and mark an implant osteotomy to the underlying bone. This passing hole could be also used for a pillar of an abutment to pass through, but preventing the abutment shoulder to be inserted in it. This would allow the socket grafting plug to be able to be connected with an abutment by means of bonding on at least part of its pillar and this way modify the shape of the latter.

1. A socket grafting plugs system configured to be used in a socket grafting process, the system comprising a plurality of socket grafting plugs, each socket grafting plug comprising
a first cross section with a first surface;
a second cross section with a second surface smaller than the first surface, the second cross section parallel to the first cross section and configured to rest on an open hole of a patient's cervical soft tissue profile; and
a body portion extending between the first cross section and the second cross section,
wherein
the first cross section of each socket grafting plug belongs to a group of first plug sections comprising at least a combination of three different shapes with three different sizes, and
the group of first cross sections and/or the group of second cross sections comprises triangles with rounded edges, squares with rounded edges, a parallelogram with rounded edges or an ovoid.

2. The socket grafting plugs system according to claim 1, wherein the body portion of each socket grafting plug belongs to a group of body portions which comprises continuous and derivable surfaces.

3. The socket grafting plugs system according to claim 2, wherein the continuous and derivable surfaces comprise combinations of plane, convex and concave surfaces.

4. The socket grafting plugs system according to claim 1, wherein the socket grafting plugs are made of a resin, a ceramic material, zirconia, PEEK, PEKTON, PMMA, PTFE, silicone, plastic, metal, a combination of at least two of them, or other biocompatible materials able to maintain stable dimensions.

5. The socket grafting plugs system according to claim 1, wherein at least one of the socket grafting plugs comprises a passing bore or a groove, suitable for a suture to pass through.

6. The socket grafting plugs system according to claim 1, wherein at least one of the socket grafting plugs comprises a passing hole, the passing hole crossing the plug from the first cross section to the second cross section and having a diameter of at least 1.5 mm.

7. The socket grafting plugs system according to claim 1, wherein each socket grafting plug comprises at least one mark configured to provide information about shape, size and/or the height of the socket grafting plug.

8. The socket grafting plugs system according to claim 1, wherein at least one of the socket grafting plugs comprises a sharp protrusion protruding from the second cross section, the protrusion being intended to be nailed into soft tissue zone and/or hard tissue zone, thus aiming to improve stabilization of the socket grafting plug in place.

9. The socket grafting plugs system according to claim 1, wherein at least one of the socket grafting plugs comprises at least one wing protruding from the first section or the body section, the wing being suitable to secure the plug to another tooth.

10. The socket grafting plugs system according to claim 1, wherein the height of each socket grafting plug is defined by the distance between the first cross section and the second cross section, the height being classified according to different heights.

11. The socket grafting plugs system according to claim 10, wherein the different heights are ten different heights.

12. The socket grafting plugs system according to claim 11, wherein the ten different heights are 2.5 mm, 3.0 mm, 3.5 mm, 4.0 mm, 4.5 mm, 5.0 mm, 5.5 mm, 6.0 mm, 6.5 mm and 7.0 mm.

13. The socket grafting plugs system according to claim 1, wherein a size of each socket grafting plug is defined by an equivalent diameter of the first cross section, wherein the equivalent diameter is the maximum distance between two points belonging to said cross section, this size being classified into different categories.

14. The socket grafting plugs system according to claim 13, wherein the different categories are at least three categories.

15. The socket grafting plugs system according to claim 14, wherein the at least three categories include a first distance between 4 and 6 mm, a second distance between 6.5 and 8.5 mm and a third distance between 9 and 12 mm.

16. The socket grafting plugs system according to claim 1, wherein at least one of the socket grafting plugs has a circular second cross section.

17. The socket grafting plugs system according to claim 1, wherein at least one of the socket grafting plugs comprises a body portion having a regular surface.

18. The socket grafting plugs system according to claim 17, wherein the regular surface is expressed by a polynomic, exponential or logarithmic mathematical formula, or a combination thereof, with a mean roughness Ra lower than 10 μm.
